(19) United States
(12) Patent Application Publication
(10) Pub. No.: US 2007/0284290 A1
(43) Pub. Date: Dec. 13, 2007

(54) Method for Dismantling Capsules and an Apparatus Using Thereof

(76) Inventor: Jie Han, Jiangsu (CN)

Correspondence Address: PERKINS COIE LLP, POST OFFICE BOX 1208, SEATTLE, WA, 98111-1208, US

(21) Appl. No.: 11/630,256

(22) PCT Filed: May 16, 2005
(86) PCT No.: PCT/CN05/00679

§ 371 Date: Dec. 21, 2006

(30) Foreign Application Priority Data
Jun. 21, 2004 (CN) 200410041070.8

(51) Int. Cl. B07B 7/00

(52) U.S. Cl. 209/133; 209/19; 241/2; 241/24.12

(57) ABSTRACT

This invention provides a method with an apparatus used during the steps of the method to dismantle capsules, the method comprising steps as firstly putting the capsules into a pressure vessel, secondly filling the pressure vessel with compressed air, to make the high-pressure air get into the capsules through the gap between the capsule body and the capsule cap, then quickly lowering the air pressure inside the pressure vessel, to generate a pressure difference between inside and outside of each capsule, making the compressed air inside each capsule expand, and at last the expansion force make the capsule body and the capsule cap be separated. Compared with the convention method of manually dismantling capsules, this method has many advantages such as more quickly dismantling, more efficiently separation of druggery and so on.

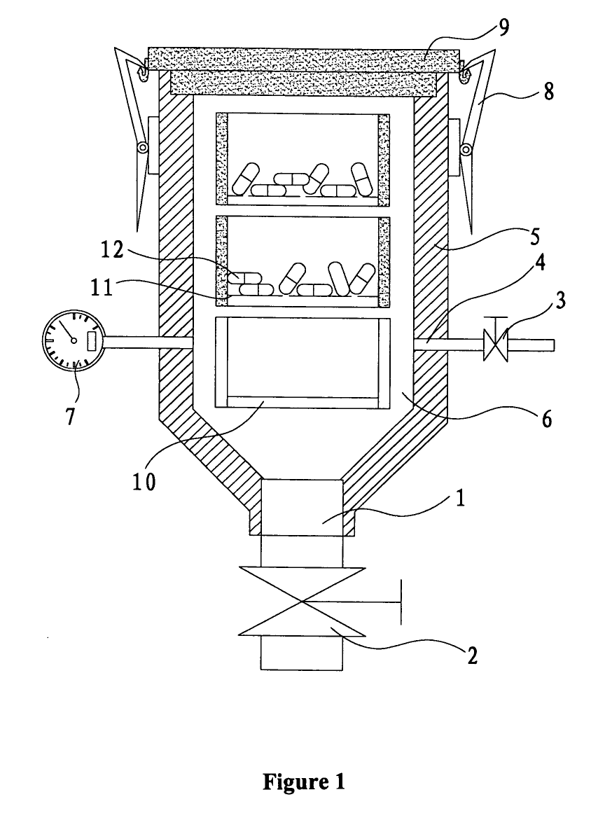

### FIELD OF INVENTION

The present invention relates to a method of dismantling capsules with a special apparatus using thereof.

### BACKGROUND OF THE INVENTION

With the development of medicine industry, the varieties and the output of medical and healthcare products nowadays grow rapidly, as well as the capsules become much more widely used in the solid preparation due to their numerous advantages. And with the development and improvement of the capsule filling apparatus, the efficiency of filling capsules rises. At present, there is nearly 3000 medical and healthcare industries and annually produce about 70 billion capsules in total.

However, because of various restricting factors, the average eligibility rate of filling capsules in medicine enterprises was 95%. The enterprises always reclaim the druggery in the 5% disqualified capsules to save the cost. The current druggery in capsules mainly presents in following forms: powder, granules, tiny troche, tiny pills, tiny vesicles, and the mixture of two or more arbitrary forms of above. At present, all of the enterprises reclaim the druggery by two ways, manually dismantling for one and smashing method for another. But each of the said two ways has various shortcomings.

1. Manually dismantling is referred to the operators using their hands to open the capsules one by one, so it leads to the following shortcomings:

A. In addition to that the dismantling velocity is too slow, it costs a lot of time and manpower, increases the manpower cost, and causes a large amount of druggery cannot be reclaimed in time;

B. Operators in direct contact with the materials causing cross-pollution with the druggery, that would not meet GMP requirements;

C. Because of the slowly dismantling, the druggery exposed in the air for a too long time would be damped and altered, resulting in affecting the efficacy of the druggery; and

D. Some security-type capsules of high degree superposition between the capsule body and cap even cannot be dismantled manually.

2. Smashing capsules is referred to putting a large amount of unqualified products into a muller to smash them, then screen out the druggery. But this method also has main shortcomings as below:

A. Granules, tiny troche, tiny pills, tiny vesicles cannot be reclaimed because their shape integrality would be mangled after smashed;

B. When the capsules with powder as well as its filler smashed, the smashed powder may contain a great amount of fragments, resulting in affecting the effective content being refilled;

C. The smashed powder containing a great amount of the capsule shell fragments may cause the density of the powder inhomogeneous, the weight of the products being refilled consequently varying, as well as the fluency in filling capsules being affected due to the shell fragments; and

D. The powder may disperse seriously during smashing process, inducing the reclaiming efficiency to be lowered.

### CONTENT OF INVENTION

The invention provides a method of capsule dismantling and an apparatus using thereof for the purpose of dismantling capsules in batches with high velocity.

The technique scheme of this invention is providing an apparatus for dismantling capsules comprising a vessel body that has a cavity, at least one inlet channel, at least one vent channel set on the vessel body, an inlet valve set on the inlet channel, and a vent valve set on the vent channel.

The principle of this invention is to use compressed air to obtain a pressure difference between inside air and outside air of the capsules, as to depart the capsule cap from the capsule body by the air pressure inside the capsules. So the druggery inside the capsules can be released and reclaimed.

Compared with the current technology, this invention has some advantages as follow:
A. The velocity of dismantling capsules is improved, even several hundreds times than the velocity of manually dismantling, so it can save a lot of manpower and be more widely applied in reclaiming druggery of various capsules;
B. In the entire process of operation, it can prevent contact between the operator and the druggery in order to avoid cross-pollution effectively;
C. It can deal with a great amount of the unqualified capsules rapidly, so the druggery can be used to fill the capsules again in time to effectively avoid transnature of the druggery;
D. It is applied for any form of druggery in capsules, such as powder, granules, tiny troche, tiny pills, tiny vesicles, and the mixture of two or more arbitrary forms of above, and the shape integrality of the druggery would not be damped in order to avoid druggery retreatment, resulting in saving the cost and improving the efficiency;
E. With the rate of separation improves, the efficiency of reclaim is also higher, and the loss of druggery during the reclaiming process should be even avoided; and
F. The process of druggery reclaiming avoids the adulteration of the shell fragments and other impurities, resulting in ensuring the purity of the druggery and not making any deteroprate, as to meet the quality requirement of medicine.

### BRIEF DESCRIPTION OF THE DRAWINGS

The FIGURE shows the front cutaway view of the apparatus for dismantling capsules; wherein components each being marked as below:

1, vent channel; 2, vent valve; 3, inlet valve; 4, inlet channel; 5, vessel body; 6, cavity; 7, manometer; 8, tache; 9, cover; 10. powder collecting plate; 11, filter screen; and 12, capsules.

### DETAILED DESCRIPTION OF THE PREFERRED EMBODIMENT

This invention provides a method of dismantling capsules, comprising steps as following: at first putting the capsules 12 that need to be dismantled into a pressure vessel; then filling the pressure vessel with compressed air, to make the compressed air get into the inner of the capsules through the gap between the capsule body and the capsule cap with high pressure; then quickly lowering the air pressure in the pressure vessel, causing a pressure difference between the inside and outside of the capsules to make the high-pressure air within the capsules expanse rapidly; at last the capsules being dismantled by the expansionary force of the inside air.

After filling the pressure vessel with compressed air, the high-pressure compressed air will firstly stave the capsules along the radial direction and then get into the inner of the capsules through the generated gap between the capsule body and the capsule cap. As a result, the air pressure inside the capsules will gradually achieve a balance level with the outside of the capsules and maintain a high pressure. The staved capsule body and capsule cap will be restored to the original shape before being staved by their own flexibility.

The air pressure in the pressure vessel should be quickly lowered by opening the valve of the pressure vessel and releasing the compressed air.

For completing the above processes, this invention also provides an apparatus for dismantling capsules.

Referring to the only one FIGURE, an apparatus for dismantling capsules as shown comprising a vessel body 5 with a cavity 6, at least one inlet channel 4, at least one vent channel 1 set on the vessel body 5, an inlet valve 3 set on the inlet channel 4, and a vent valve 2 set on the vent channel 1. A cover 9 set on top of the said vessel body 5, is connected with the said vessel body 5 at one side by a hinge, and at the other side by a tache 8. A manometer 7 that used to meterage the air pressure in the cavity 6 is set on the vessel body. A filter screen 11 is also placed in the cavity 6, and below the said filter screen 11 is set a powder collecting plate 10.

Referring to the indicated FIGURE, the pressure vessel is made of stainless steel, so it can bear great pressure inside the pressure vessel and has the excellent function of airproof. The vessel has an inlet for incoming druggery, an inlet channel 4 for compressed air, a vent channel 1 for compressed air and a interface for combination with the manometer 7. For the capsules are filled under the normal pressure in standard atmosphere, so inside the capsules 12 exist druggery and more or less air with normal-level pressure. Put the capsules 12 that need to be dismantled into the cavity 6, then close the druggery inlet and shut the vent channel 1 to pressurize the vessel, and then pump compressed air into the cavity 6 through the inlet channel 4 to generate an air pressure difference between inside and outside of the capsules 12 making the capsules 12 staved along the radial direction, so the compressed air can accordingly get to the inside of the capsules 12 through the gap between the capsule body and capsule cap. Then the air pressure difference gradually evanesces and the air pressure should achieve a new balance and maintain a high level between the inside and outside of the capsules 12. After the majority of the capsules 12 staved being restored to the original shape by their own flexibility, close the inlet valve 3 and quickly open the vent valve 2 in order to instantly release the compressed air in the cavity 6, to make the air pressure inside the cavity 6 return the normal level. Then the compressed air having gotten into the capsules 12 will expand rapidly under the difference of air pressure between the inside and outside of the capsules 12. The capsule body and the capsule cap will be separated by the expansion force. The pressure could be ensured by the capsule shell is much larger than the depart force, so the majority of capsules' body and cap could be integrally separated perfectly without being exploded, resulting in that the druggery inside the capsules can be purely screened out. Some capsules staved that cannot be restored to the former shaper, should be restored to their original shape by the expansion force that caused by the air pressure difference between the inside and outside of the capsules 12, and then the capsule body and capsule cap can be separated with the expansion force.

According to different capsule products with different druggery inside, we can adjust the parameters such as the velocity of inlet flow, the air pressure inside the vessel, the period to keep the air pressure at a high level and the air vent velocity, in order to increase the capsule separating efficiency and the druggery reclaiming efficiency.

1. A method of dismantling capsules, wherein:
At first put the capsules that need to be dismantled into the pressure vessel; secondly
Fill the pressure vessel with compressed air, making the compressed air with high pressure get into the inner of the capsules through the gap between the capsule body and the capsule cap; then
Quickly lower the air pressure of the pressure vessel, to make the high pressure-air in the capsules be expanded rapidly under the pressure difference between the air inside and outside the capsules; and at the end
The capsules will be dismantled by the expansionary force.

2. The method of dismantling capsules as claimed in claim 1, wherein after filling the pressure vessel with compressed air, the high-pressure air will first stave the capsules along the radial direction and get into the inner of the capsules through the gap between the capsule body and the capsule cap, and as a result, the air pressure inside the capsules will gradually achieve a balance with the air pressure outside the capsules, moreover maintaining a high level.

3. The method of dismantling capsules as claimed in claim 2, wherein the staved capsule body and capsule cap can be restored under their own flexibility to the original shape.

4. The method of dismantling capsules as claimed in claim 1, wherein the air pressure inside the pressure vessel should be quickly lowered by opening the valve of the pressure vessel and releasing the compressed air.

5. An apparatus for dismantling capsules, comprising
a vessel body (5) with a cavity (6), at least one inlet channel (4) and at least one vent channel (1) set on the vessel body (5);
an inlet valve (3) set on the inlet channel (4); and
a vent valve (2) set on the vent channel (1).

6. The apparatus for dismantling capsules as claimed in claim 5, wherein a cover (9) set on top of the said vessel body (5), the said cover (9) and the said vessel body (5) being connected at one side by a hinge, while the said cover (9) and the said vessel body (5) being connected at the other side by a tache (8).

7. The apparatus for dismantling capsules as claimed in claim 5, wherein a manometer (7) used to measure the air pressure in the cavity (6) of the vessel body (5) is set on the vessel body (5).

8. The apparatus for dismantling capsules as claimed in claim 5, wherein a filter screen (11) is located in the cavity (6) for laying capsules (12) above a powder collecting plate (10).
